(19) United States
(12) Patent Application Publication
(10) Pub. No.: US 2006/0233580 A1
(43) Pub. Date: Oct. 19, 2006

(54) Image output apparatus and printer driver

(75) Inventors: Naofumi Ueda, Kyoto (JP); Katsuyoshi Fujiwara, Osaka (JP); Yuji Okamoto, Kyoto (JP); Syoichiro Yoshiura, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/398,963

(22) Filed: Apr. 5, 2006

(30) Foreign Application Priority Data
Apr. 15, 2005 (JP) 2005-118499
Apr. 15, 2005 (JP) 2005-118500

(51) Int. Cl. B41J 5/30

(52) U.S. Cl. 400/62

(57) ABSTRACT

In one embodiment, an image output apparatus is configured such that an equipment control portion sets the process of output as an image according to the protection status of received direct print data. When the received direct print data is only simple data in a predetermined file format, the equipment control portion sets a processing method that unconditionally prints out the data, and when the data is encrypted, the equipment control portion sets a processing method that temporarily holds the data, and prints out the data in response to a user's output instruction, and when a password has been added to the data, the equipment control portion sets a processing method that temporarily holds the data, and prints out the data in response to password input from the user.

### CROSS REFERENCE TO RELATED APPLICATIONS

This application claims priority under 35 U.S.C. § 119(a) on Patent Application No. 2005-118499 and Patent Application No. 2005-118500 filed in Japan on Apr. 15, 2005, the entire contents of which are hereby incorporated by reference.

### BACKGROUND OF THE INVENTION

1. Field of the Invention

The present invention relates to an image output apparatus and printer driver that print out an image based on data received from inside or data received from outside, and more specifically, relates to an image output apparatus and printer driver in which it is possible to set a printout processing method according to the status of data received for direct print.

2. Related Art

In a conventional printing method, a user starts up a necessary application on a personal computer, opens a file for printing, and by selecting in order, for example, “File”, “Print”, and “Execute” from a screen of that open file data, and starts printing.

On the other hand, recently, a direct print function has been proposed in which, by throwing data as-is to the printer without opening such an application, the data is decompressed at the printer and immediately printed out (for example, see JP 2002-351637A).

In this case, it is standard in direct print to immediately print out the received data, but when the received data is all printed out without conditions, there is a possibility that problems will occur, such as a third party viewing data the user wishes not to be seen, or when a third party comes to take a document they printed out, mistakenly taking also the document that the user printed.

Thus, separate from such a direct print function, a print hold function has also been proposed in which the received data is held, the user goes to the printer, a list of held data is displayed, and printing out is executed by the user selecting data to print from that list.

Also, a confidential print function has been proposed in which after the user sets a password for the data and sends a print instruction, the user goes to the printer, and by there inputting the set password from an unshown operating panel or the like, printing out is started (for example, JP H2-268321).

In this way, various printing methods have recently been proposed, such as direct print, print hold, and confidential print.

Incidentally, there are various forms of data sent via a network path, such as data sent after having been encrypted and data sent after having been password-protected. In this case, there is no particular obstacle to immediately printing out data that has not been encrypted or password-protected at the point in time that the data has been thrown to the printer.

On the other hand, with respect to data that is sent after having been encrypted, for example, even if an attempt is made to immediately print at the point in time the data has been thrown to the printer, when that encryption was not in a prescribed encryption format, there is a possibility that the encryption cannot be deciphered and it will not be possible to print. Also, in consideration of recent spam mails, damage caused by electronic viruses, and the like, it is not known in the first place whether or not data sent after being encrypted is free of problems. Considering such circumstances, when encrypted data has been sent as direct print, it is a problem to unconditionally immediately print out the data.

On the other hand, data that is sent as password-protected data can be opened by the user who received this data entering the password on a personal computer, but when this opened data is printed out with the above confidential print, the trouble of reentering a password for confidential print and then sending the data to the printer is necessary.

### SUMMARY OF THE INVENTION

It is an object of the present invention to provide an image output apparatus and printer driver in which it is possible to automatically set the print out method to an optimum method according to the protection status of the received data.

The image output apparatus of the present invention, which outputs an image based on data received from outside, includes a protection status confirmation portion (protection status confirmation means) that confirms a protection status of the received data; and a control portion (control means) that controls an output process of the image according to the protection status of the data that has been confirmed by the protection status confirmation portion. Here, “data protection status” means “status with respect to data protection”, and specifically means, for example, a state in which data itself is encrypted and a state in which a password has been added to data.

Also, in the image output apparatus, a setting portion may be provided that sets the process of output as an image according to the protection status of the received data. Also, a configuration may be adopted in which the control portion is provided with an encryption confirmation portion that confirms a presence or absence of encryption for the received data, and the setting portion sets the process of output as an image according to the presence or absence of encryption that has been confirmed by the encryption confirmation portion. Or, a configuration may be adopted in which the control portion is provided with a password confirmation portion that confirms the presence or absence of a password for the received data, and the setting portion sets the process of output as an image according to the presence or absence of a password that has been confirmed by the password confirmation portion. Here, “setting the process of output” specifically means, for example, setting a processing method of any of direct print, print hold, and confidential print.

Also in the image output apparatus, a configuration may be adopted in which, when the control portion has confirmed that the received data is encrypted or that a password has been added, when performing output as an image (i.e., when printing out), print out is started by an instruction from the user according to the procedure for print hold or confidential print.

Alternatively, the image output apparatus may be an image output apparatus that prints out an image based on data received from outside, and that includes a processing method setting portion (processing method setting means) that sets, in advance, a method of print processing when direct print data is received.

Also, a configuration may be adopted in which the processing method setting portion sets a processing method that unconditionally prints out when the received direct print data is only simple data in a predetermined file format; sets a processing method that temporarily holds the data, and prints out the data in response to the user's output instruction when the received data is encrypted; and sets a processing method that temporarily holds the data, and prints out the data in response to password input from the user when a password has been added to the received data.

Also, the image output apparatus may be provided with an output setting portion (output setting means) for setting whether or not to print the received direct print data. Further, the user may be able to perform settings as desired using this output setting portion. Thus, it is possible to set a print out processing method for each data protection status.

Also, in the image output apparatus, data processed for direct print and data processed by a print instruction from an ordinary driver may be classified and displayed as a job list (for example, a hold job list, output complete job list, and the like).

Also, a configuration may be adopted in which the image output apparatus further includes a deleting portion (deleting means) that deletes from within the apparatus whose output is delayed when a holding period set in advance passes, and different holding periods are set for data being held for direct print and data being held by a print instruction from an ordinary driver. That is, the handling of data being held for direct print and data being held by an instruction from a driver may be divided up. Also, a configuration may be adopted in which the data is displayed divided when displayed in a list, and the user is allowed to select which to display. Here, as the holding period, in the case of direct print, because it may take some time until noticing when data has been sent, it is preferable to make the holding period for direct print longer than the holding period for a print instruction from an ordinary driver. However, from the viewpoint of security, it is preferable to make the holding period for direct print short.

With the image output apparatus configured in the above manner, it is possible to set the print out processing method according to the protection status of the data received for direct print. That is, it is possible to automatically set the print out method to any of direct print, print hold, and confidential print according to whether the received data is data created in a prescribed file format and transmitted as-is, or data that has been transmitted after encryption, or data that has been transmitted after being password-protected.

Alternatively, the image output apparatus may be an image output apparatus that prints out an image based on data received from outside, and that includes a judgment portion (judgment means) that judges whether or not usage restriction information is attached to the received data; an output restriction portion (output restriction means) that restricts output of the received data with the data in a saved state when it has been judged by the judgment portion that usage restriction information has been attached; a holding portion (holding means) that holds the usage restriction information attached to the data as output condition information that makes it possible to output data whose output has been restricted by the output restriction portion, and an input portion (input means) that inputs the output condition information when a request is made to output the data whose output has been restricted. Here, “usage restriction information” means, for example, a so-called password. “Output condition information” means, for example, a so-called confidential print security code.

With the image output apparatus configured in the above manner, when a password has been added to the data received from outside, by reusing that password as-is as the confidential print security code when printing out, when the user who received the data has attempted to print out with confidential print, it is possible to eliminate the trouble of again inputting a confidential print security code at that time. That is, password-protected data received from outside can be allowed to automatically link to a conventional confidential print function.

Also, when the received data was, for example, direct print data, it is possible that the user will not notice when that was sent. Accordingly, in the image output apparatus of the present invention, a notification portion (notification means) may be further provided that notifies that data received from outside is saved in the print hold state, restricting output of the data. Thus, it is possible for the user to reliably know that data that has been sent as direct print is in the print hold state.

Alternatively, the printer driver of the present invention is a printer driver that generates print data toward an image recording apparatus that has a confidential print function, including a judgment portion (judgment means) that judges whether or not a password is attached to the received data when generating held data as print data; and a job generating portion (job generating means) that generates print data in which the password is made a confidential print security code when it has been judged by the judgment portion that a password has been attached.

With a printer driver having this sort of configuration, when a password has been attached to data, by reusing that password as-is as the confidential print security code when printing out, the password-protected data can be automatically handled as confidential print when printing out. That is, it is possible to eliminate the trouble of the user who received this data again inputting a confidential print security code. That is, data received with password-protection can be allowed to automatically link to a conventional confidential print function.

Also, the printer driver may be further provided with a notification portion (notification means) that notifies the user that the print data will be processed as print hold, and that the security code, which is the hold code when that processing is performed, is the password that was attached to the data. Thus, because the user can know that password-protected data is being held in the printer as confidential print, and that the confidential print security code for the data is the password, the user can go to the printer and reliably print out that confidential print.

### BRIEF DESCRIPTION OF THE DRAWINGS

FIG. 1 is a general configuration diagram that shows the overall electrical configuration of a digital multifunction equipment according to one embodiment of the present invention and the connective relationships with peripheral devices.

FIG. 2 is an illustrative diagram that shows the configuration of an operating portion.

FIG. 3 is an illustrative diagram that shows a procedure that sets a print out processing method in the equipment.

FIG. 4 is an illustrative diagram that shows the procedure that sets the print out processing method in the equipment.

FIG. 5 is an illustrative diagram that shows the procedure that sets the print out processing method in the equipment.

FIG. 6 is an illustrative diagram that shows the procedure that sets the print out processing method in the equipment.

FIG. 7 is an illustrative diagram that shows the procedure that sets the print out processing method in the equipment.

FIG. 8 is an illustrative diagram that shows the procedure that sets the print out processing method in the equipment.

FIG. 9 is an illustrative diagram that shows the procedure that sets the print out processing method in the equipment.

FIG. 10 is a flowchart that shows a processing operation of the equipment when direct print data is received.

FIG. 11 is a flowchart that shows print processing for data that has been held in a hard disk.

FIG. 12 is an illustrative diagram that shows a procedure that executes print processing for data that has been held in the hard disk.

FIG. 13 is an illustrative diagram that shows the procedure that executes print processing for data that has been held in the hard disk.

FIG. 14 is an illustrative diagram that shows the procedure that executes print processing for data that has been held in the hard disk.

FIG. 15 is an illustrative diagram that shows an example of a display of a print hold list after execution of print processing.

FIG. 16 is a flowchart that shows a processing operation of print hold with a printer driver of a terminal apparatus.

FIG. 17 is an illustrative diagram that shows an example of a display screen when setting print settings with the terminal apparatus.

FIG. 18 is an illustrative diagram that shows an example of the display screen when setting print settings with the terminal apparatus.

FIG. 19 is an illustrative diagram that shows an example of the display screen when setting print settings with the terminal apparatus.

FIG. 20 is an illustrative diagram that shows an example of the display screen when setting print settings with the terminal apparatus.

FIG. 21 is an illustrative diagram that shows a procedure that executes print processing for data that has been held in the hard disk.

FIG. 22 is an illustrative diagram that shows the procedure that executes print processing for data that has been held in the hard disk.

### DESCRIPTION OF THE PREFERRED EMBODIMENTS

Hereinafter, embodiments of the present invention will be described with reference to the accompanying drawings.

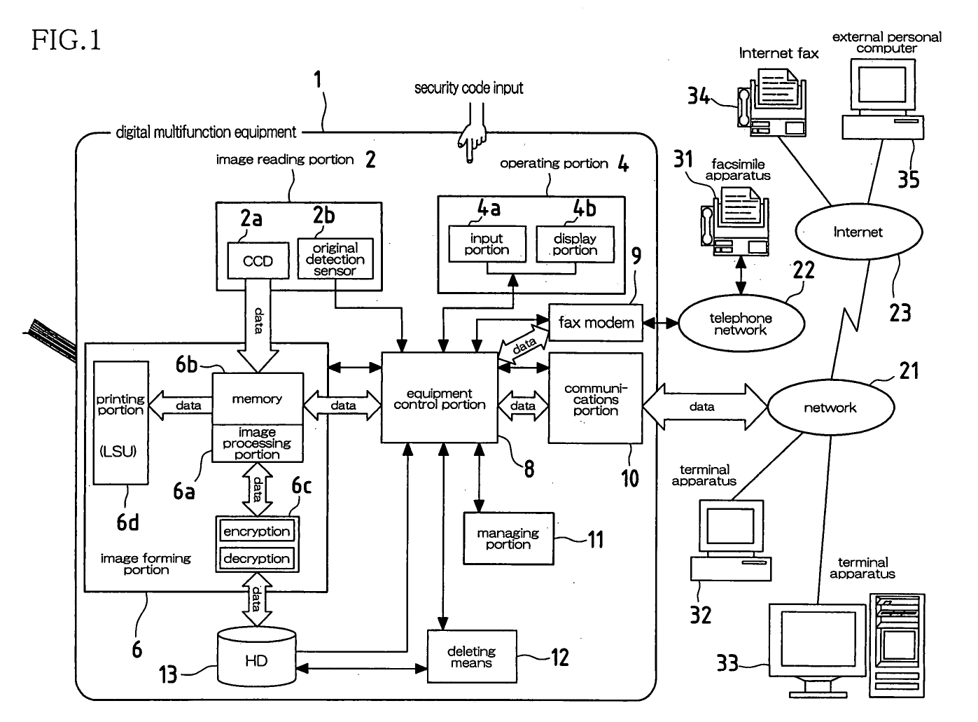

In the present embodiment, a case is described in which the image output apparatus of the present invention is applied in a digital multifunction equipment. FIG. 1 shows the overall electrical configuration of such a digital multifunction equipment and the connective relationships with peripheral devices.

First, the electrical configuration of this digital multifunction equipment 1 is described.

As shown in FIG. 1, the digital multifunction equipment 1 includes an image reading portion 2, an operating portion 4, an image forming portion 6, an equipment control portion 8, a fax modem 9, a communications portion 10, a managing portion 11, a deleting means 12, and a hard disk (HD) 13. That is, the digital multifunction equipment 1 of the present embodiment is a fax and network printer multifunction equipment.

The image reading portion 2 includes a CCD 2a and an original detection sensor 2b.

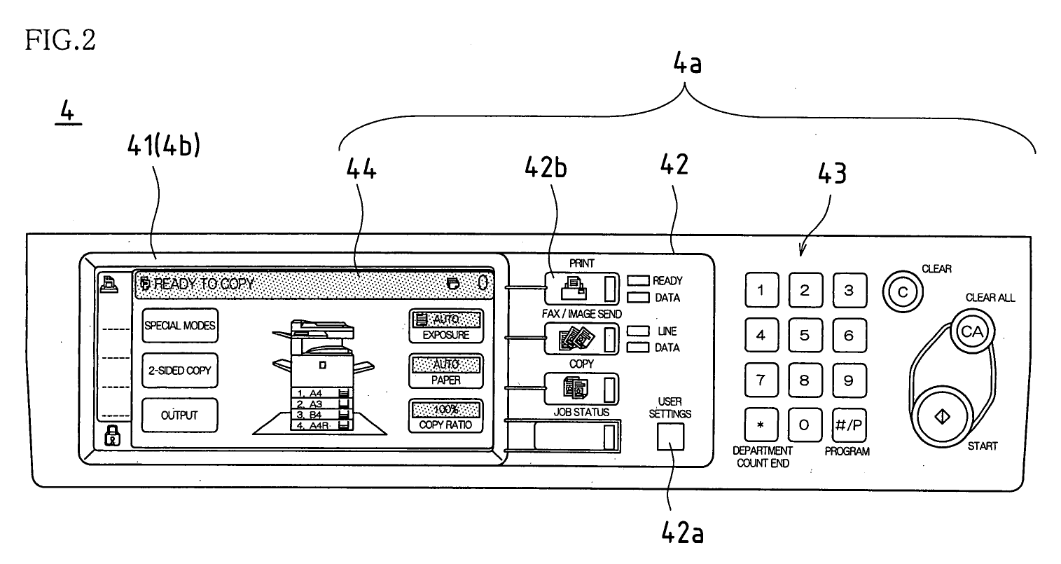

The operating portion 4 includes an input portion 4a configured from various functions buttons that are mechanical keys and a touch panel described below, and a display portion 4b configured from a display panel of liquid crystal or the like. FIG. 2 shows the configuration of the operating portion 4. The display portion 4b has a configuration in which a transparent touch panel 44 is disposed on the top face of a display panel 41, and various function buttons 42 and numeric keys 43 are disposed to the side of the display portion 4b (the right side in the figure). Further, a start button, a clear all (CA) button and a clear (C) button are disposed to the right side of the numeric keys 43.

The image forming portion 6 includes an image processing portion 6a that has a working memory 6b in which print data is decompressed; an encrypting/decrypting portion 6c that encrypts and temporarily parks (saves) data from outside in the hard disk 13 in order to preserve the data within the equipment, and decrypts the data parked in the hard disk 13 and transfers it to the image processing portion 6a; a printing portion 6d that has a laser scanning unit (LSU), and the like.

The equipment control portion 8 manages operating control of the entire equipment, and is configured by a CPU, ROM, RAM, and the like. The managing portion 11 manages information necessary for operation of the equipment, and when, for example, sending and receiving communications, manages email addresses and fax telephone numbers. Also, the managing portion 11 collectively manages information necessary for operation of the equipment, such as management of position information (address information) for data temporarily parked in the hard disk 13, and management of position information for outputting data to the printer when operating in printer mode.

The communications portion 10 performs bidirectional communications with a network 21, and in the present embodiment, is a printer board provided with a memory for decompressing the received data into data the equipment can handle. Accordingly, with the communications portion 10, while the received data is decompressed in this memory, the received data is successively transferred to the working memory 6b.

The deleting means 12 performs processing that deletes data temporarily parked in the hard disk 13 by the control of the equipment control portion 8 when a holding period described later has passed.

In the digital multifunction equipment 1 with the above configuration, in a facsimile apparatus 31 that, for example, an administrator manages, is connectable to the fax modem 9 via a telephone network 22, terminal apparatuses (personal computers) 32, 33, and the like are connected to the communications portion 10 via the network 21, which is a LAN or the like, and an Internet fax 34 and an external personal computer 35 and the like are connectable to the communications portion 10 via the Internet 23. The digital multifunction equipment 1 of the present embodiment is disposed in this sort of a network environment.

The present embodiment has a configuration in which data received from outside via the network is decompressed into data that the equipment can handle in the communications portion 10, and so it is possible to confirm the protection status of the received data in the communications portion 10. That is, it is possible to confirm whether it is data in prescribed file format without any processing or additions, whether the data is encrypted, whether the data is password-protected, and the like. Accordingly, in the present embodiment, the equipment control portion 8 afterward automatically sets the print out processing method for the received data based on the results of confirmation with the communications portion 10.

<Description of Setting Print Out Processing Method in Equipment>

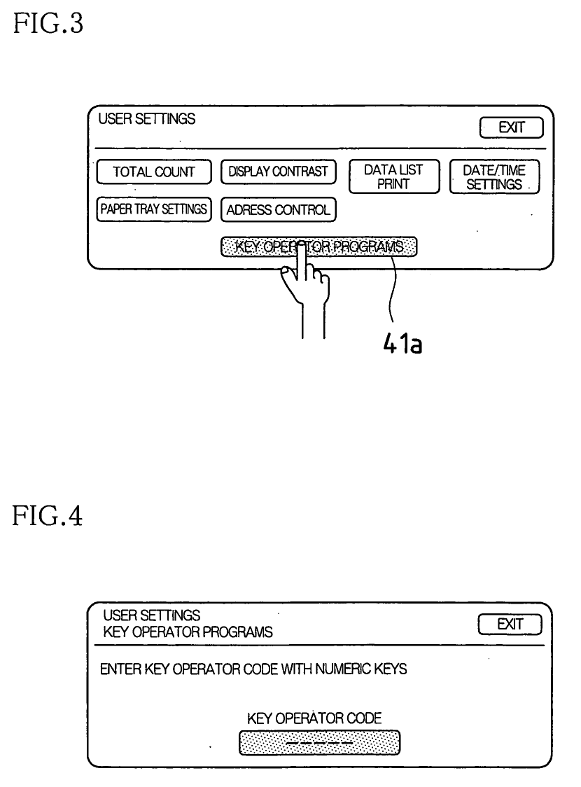

Here, as preprocessing in order to automatically set the print out processing method with the equipment control portion 8, a procedure in which a user sets a print out processing method in the equipment is specifically described with reference to FIGS. 3 to 9.

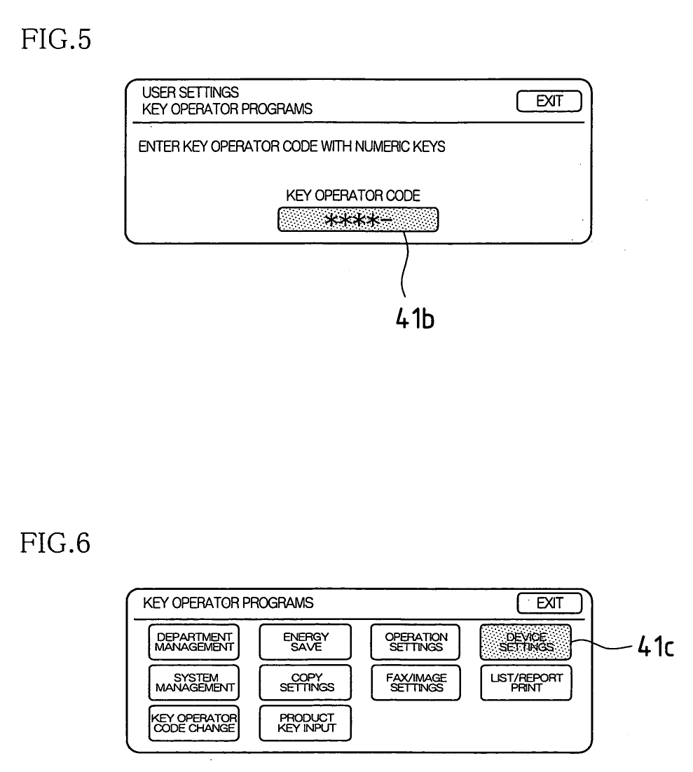

When setting the print out processing method in the equipment, first, the user presses a function button 42a labeled “USER SETTINGS” in the input portion 4a shown in FIG. 2. Thus, a user settings screen shown in FIG. 3 is displayed in the display portion 4b. This user settings screen is for setting the operation of the equipment, and various settings keys are provided: “TOTAL COUNT”, “DISPLAY CONTRAST”, “DATA LIST PRINT”, “DATE/TIME SETTINGS”, “PAPER TRAY SETTINGS”, and “ADDRESS CONTROL”. However, the content of these keys is not a requirement of the present invention, and so a description of them will be omitted. Also, a touch key labeled “KEY OPERATOR PROGRAMS” is provided in this user setting screen in order to perform more detailed settings. Accordingly, by the user touching a touch key 41a labeled “KEY OPERATOR PROGRAMS”, a settings screen for USER SETTINGS/KEY OPERATOR PROGRAMS shown in FIG. 4 is displayed in the display portion 4b. This settings screen requires, for example, five digit code input, and so, as shown in FIG. 5, when a code is successively entered in a code input window 41b, a settings screen for the key operator programs shown in FIG. 6 is shown in the display portion 4b. However, this settings screen is mainly operated by an equipment administrator, a service personnel, or the like, and is not handled by ordinary users.

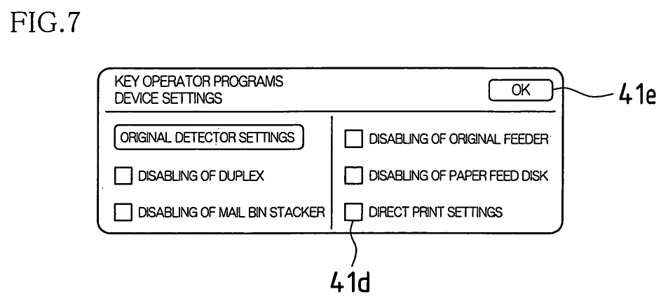

Various settings keys are provided on this settings screen: “DEPARTMENT MANAGEMENT”, “ENERGY SAVE”, “OPERATION SETTINGS”, “DEVICE SETTINGS”, “SYSTEM MANAGEMENT”, “COPY SETTINGS”, “FAX/IMAGE SETTINGS”, “LIST/REPORT PRINT”, “KEY OPERATOR CODE CHANGE”, and “PRODUCT KEY INPUT”. However, in the present embodiment, in order to set handling of password-protected data described below, only “DEVICE SETTINGS” is used, and so a description of the operation of other settings keys is omitted. Here, when the user touches a touch key 41c labeled “DEVICE SETTINGS”, a device settings screen for the key operator programs shown in FIG. 7 is displayed.

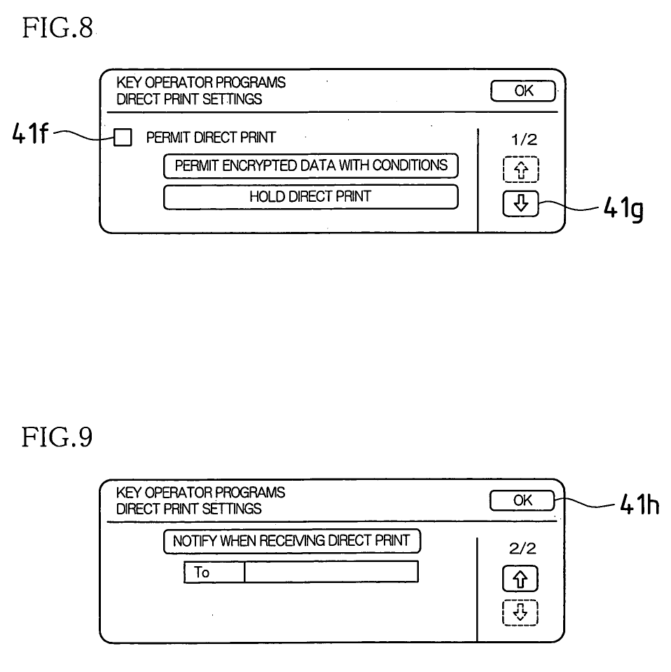

Various settings keys are provided on this device settings screen: “ORIGINAL DETECTOR SETTINGS”, “DISABLING OF DUPLEX”, “DISABLING OF MAIL BIN STACKER”, “DISABLING OF ORIGINAL FEEDER”, “DISABLING OF PAPER FEED DISK”, and in addition, “DIRECT PRINT SETTINGS”, which is a feature of the present invention. Here, when the user places a check in a side check box 41d labeled “DIRECT PRINT SETTINGS” and touches an “OK” button 41e in the upper right of the display, a direct print settings screen for the key operator programs shown in FIG. 8 is displayed.

A selection box (check box) 41f that selects whether or not direct print is permitted is provided in this direct print settings screen. Accordingly, when a check is placed in this check box, internal processing is set, as displayed below, such that the equipment control portion 8 permits encrypted data with conditions (i.e., makes holding a condition), and holds direct print.

Also, after the user has placed a check in the check box 41f, by operating a downward-pointing cursor button 41g, a direct print settings screen for the key operator programs shown in FIG. 9 is displayed in the display portion 4b.

This direct print settings screen is set, for example, in the case that, when direct print data has been received, the equipment administrator or the like wants to be notified that direct print data has been received. In this case, because the digital multifunction equipment 1 of the present embodiment possesses an Internet fax function, this notification is made using the mail function. Accordingly, the user sets the mail address of a desired person as the notification recipient on this settings screen. Afterward, by touching an “OK” button 41h in the upper right of the screen, all settings are finished. That is, the screen again transitions to the state shown in FIG. 2.

<Description of Processing when Direct Print Data is Received>

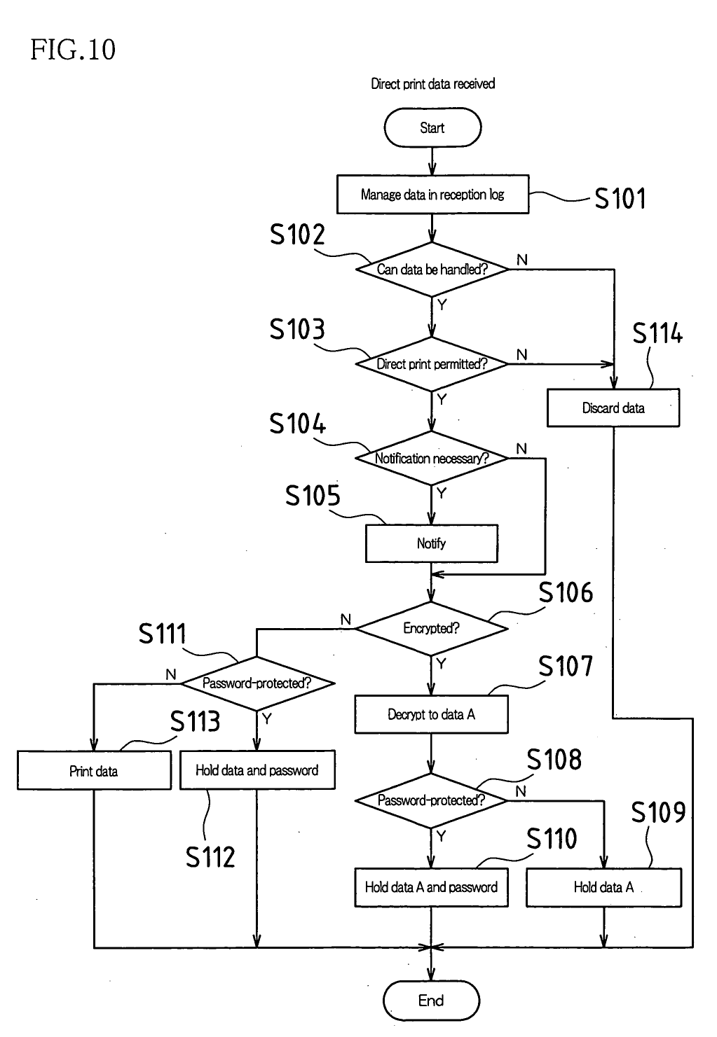

Next is a description of the processing operation of the equipment when direct print data is received with reference to the flowchart shown in FIG. 10, for the case when the equipment is set as described above. However, this description is made with three types of data given as examples of received direct print data: data created in a prescribed file format, encrypted data, and password-protected data.

When direct print data is received, in order to leave behind a reception history such as the date and time of reception, the equipment control portion 8 stores a reception log of the received data in the managing portion 11 (Step S101). Afterward, the received data is decompressed, and confirmation is made of whether or not the data can be handled (for example, data in PDF or FIFF file format) (Step S102).

When the equipment control portion 8 judges as a result that the data cannot be handled (when judged NO in Step S102), the equipment control portion 8 advances the operation to Step S114, the data is immediately discarded and the processing is finished. On the other hand, when the equipment control portion 8 judges that the data can be handled (when judged YES in Step S102), next, based on the above settings, it confirms whether or not direct print is permitted (Step S103). When, as a result, direct print is not permitted (i.e., when a check is removed in the settings screen in FIG. 8), the equipment control portion 8 advances the operation to Step S114, the data is immediately discarded and the processing is finished.

On the other hand, in this example, direct print is permitted, and so next, based on the above settings, the equipment control portion 8 confirms whether or not the equipment administrator or the like will be notified that direct print data has been received (Step S104). When, as a result, notification to the equipment administrator or the like is set (when a mail address is set for the notification recipient in the settings screen in FIG. 9), notification is made to the mail address that direct print data has been received (Step S105). On the other hand, when notification to the equipment administrator or the like is not set, notification is not made.

Next, the equipment control portion 8 confirms whether or not the received data is encrypted (Step S106). When the result is that the data is encrypted (when judged YES in Step S106), in a state in which the received data has been decrypted and the data has been decompressed (data A) to the working memory 6b of the image processing portion 6a (Step S107), next, the equipment control portion 8 confirms whether or not the data A is password-protected (Step S108). When the result is that it is not password-protected (when judged NO in Step S108), the decompressed data A is saved (parked) to a predetermined region of the hard disk 13 and held (Step S109). On the other hand, when the result is that the decompressed data A is password-protected (when judged YES in Step S108), the decompressed data A is saved along with its password to a predetermined region of the hard disk 13 and held (Step S110).

On the other hand, when it has been judged in Step S106 that the received data is not encrypted (when judged NO), next, the equipment control portion 8 confirms whether or not the received data is password-protected (Step S111). When the result is that the received data is not password-protected (when judged NO in Step S111), because it is ordinary data that has not been encrypted or password-protected (for example, ordinary data in PDF format), the received data is immediately printed out without being held in the manner of the standard direct print function (Step S113). On the other hand, when the received data is password-protected (when judged YES in Step S108), the received data is saved along with its password to a predetermined region of the hard disk 13 and held (Step S112).

That is, in the present embodiment, when direct print data is received, the received data is immediately printed out without conditions in the case that it is simple data in a predetermined file format. In the case that the received data is encrypted, it is temporarily held, and in the case that the received data is password-protected, it is temporarily held along with its password.

<Description of Print Hold Processing>

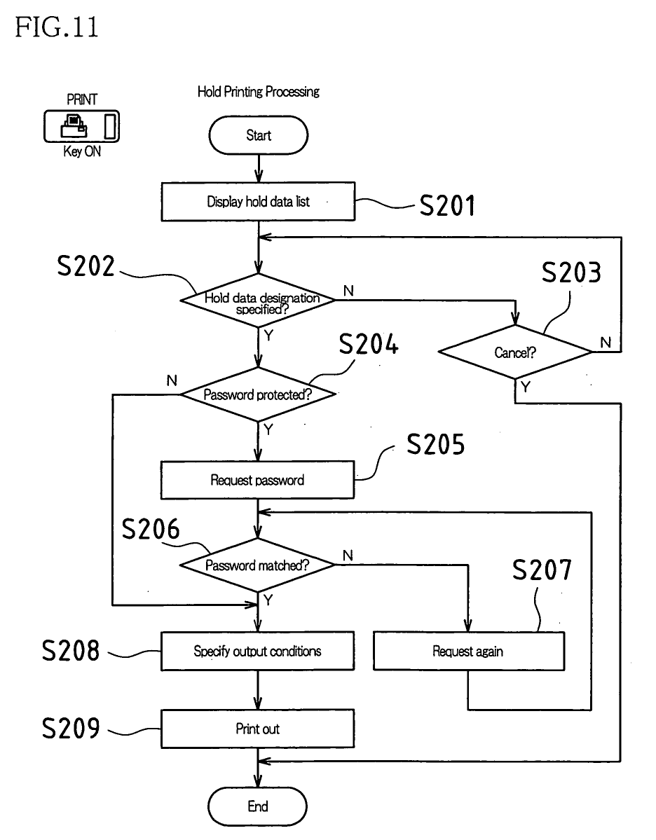

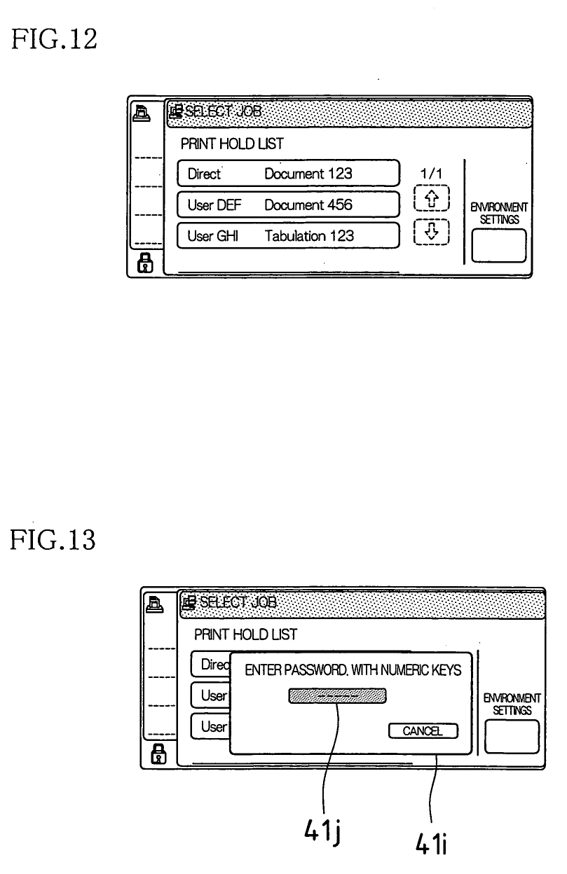

Next is a description of the print processing operation for data that has been held in the hard disk 13 by the above processing performed when direct print data is received, with reference to the flowchart shown in FIG. 11, and the examples of the display screens of the display portion 4b shown in FIGS. 12 to 15.

When printing data that has been held, the user presses a function button 42b labeled “PRINT” in the input portion 4a shown in FIG. 2. Thus, a list screen of a print hold list (job list) shown in FIG. 12 is displayed (Step S201). The user selects data to be printed from this list screen (Step S202). Here, when data to be printed has not been selected from this list screen (when judged NO in Step S202), confirmation is made with the user of whether or not to cancel print hold (Step S203), and when the user selects cancel, processing is finished as-is. On the other hand, when the user merely made a mistake or the like and does not intend to cancel, the operation returns to Step S202 and the user again selects the data to be printed.

On the other hand, when the desired data has been selected in Step S202 (when judged YES), the equipment control portion 8 confirms whether or not the data is password-protected (Step S204).

Here, data “Direct Document 123” that is received for direct print, document “Document 456” whose username is “User DEF” transmitted from a terminal apparatus (for example, terminal apparatus 32) within the local area network 21, and tabulation data “Tabulation 123” whose username is “User GHI” transmitted from another terminal apparatus (for example, terminal apparatus 33) within the local area network 21, are displayed as the print hold list on the list screen of the print hold list shown in FIG. 12. Of these, it is supposed that the data of “Direct document 123” was password-protected. When there is also other data that is being held from printing, by touching the up/down cursor keys on the right side (the cursor key pointing downward in FIG. 12), it is possible to sequentially change the display of the print hold list in a manner like turning pages.

When the result of the confirmation in Step S204 is that the selected data is password-protected (i.e., when “Direct document 123” has been selected), as shown in FIG. 13, a password input screen 41i is displayed superimposed on the print hold list screen in the display portion 4b (Step S205). Accordingly, the user inputs the five digit password in an input window 41j of the password input screen 41i.

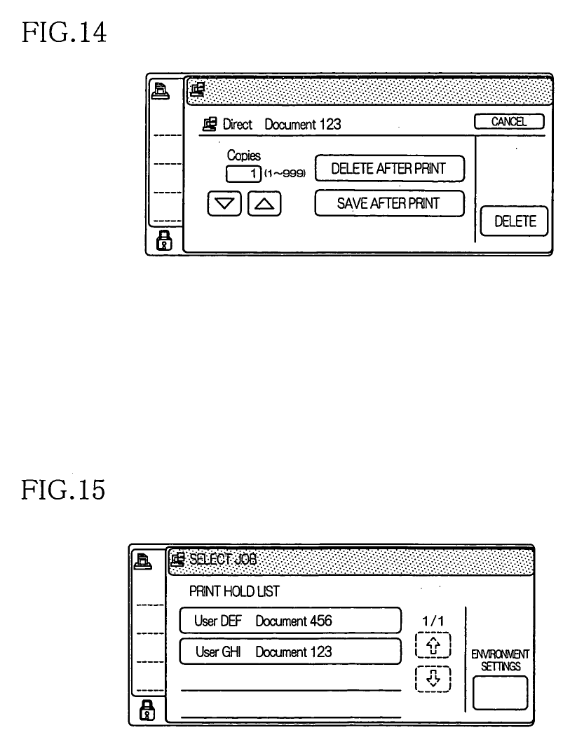

The equipment control portion 8 confirms whether or not the input password matches the password that has been saved with the data in the hard disk 13 (Step S206). When the result is that the passwords do not match (when judged NO in Step S206), password input is requested again (Step S207), and the operation returns to the processing in Step S206. On the other hand, when the passwords match (when judged YES in Step S206), an output condition settings screen is displayed in the display portion 4b, as shown in FIG. 14.

The user sets output conditions in this output condition settings screen (Step S208). Specifically, the number of output copies is set in this output condition settings screen. Also, setting is performed for how to handle the data after printing.

Here, when “DELETE AFTER PRINT” is selected, after the data for this “Direct Document 123” is printed out (Step S209), the data for “Direct Document 123” will be deleted from the hard disk 13. That is, in this case, after returning to the print hold list screen, as shown in FIG. 15, “Direct Document 123” is deleted, and only document “Document 456” whose username is “User DEF” and tabulation data “Tabulation 123” whose username is “User GHI” are displayed.

On the other hand, when “SAVE AFTER PRINT” is selected, after the data for this “Direct Document 123” is printed out (Step S209), the data for “Direct Document 123” is saved in the hard disk 13. That is, in this case, after returning to the print hold list screen, the print hold list screen shown in FIG. 12 is displayed.

Here, in the above description, as shown in the print hold list screen in FIG. 12, data received from outside via the Internet 23 and being held (“Direct Document 123”), and data received from the terminal apparatuses 32, 33 and the like via the network 21 and being held (“User DEF Document 456” and “User GHI Tabulation 123”), is displayed in a list without being distinguished. However, this print hold list may be displayed with the data distinguished. That is, the screen may be displayed with the print hold list of data received from outside via the Internet 23 and being held, and the print hold list of data received from the terminal apparatuses 32, 33, and the like via the network 21 and being held, distinguished. In this case, the list screen may be switched by touch-operating the up/down cursor keys on the right side of the screen shown in FIG. 12. Also, in the above description, a configuration was described in which when pressing the function button 42b labeled “PRINT” in the input portion 4a shown in FIG. 2, the list screen for the print hold list shown in FIG. 12 is displayed, but a configuration may also be adopted in which when the function button 42b labeled “PRINT” has been pressed, a confirmation screen (not shown) that makes an inquiry to the user of which print hold list to display is displayed in the display portion 4b, and by the user selecting either list with this confirmation screen, the selected print hold list is displayed in the display portion 4b in a form as shown in FIG. 12.

Also, in the present embodiment, a deleting means 12 is provided that deletes data from the hard disk 13 whose output (printing out) is delayed when a holding period set in advance passes. That is, when the holding period set in advance passes, the equipment control portion 8 controls the deleting means 12 so that data in the hard disk 13 whose holding period has passed is deleted. In this case, different holding periods may be set for data being held for direct print (“Direct Document 123”) and data being held by a print instruction of a printer driver of the terminal apparatuses 32 and 33 (“User DEF Document 456” and “User GHI Tabulation 123”). That is, the treatment of data being held for direct print and data being held by an instruction from the printer driver of the terminal apparatuses 32 and 33 is allowed to differ. Specifically, in the case of direct print, because it may take some time until noticing when data has been sent, it is conceivable to make the holding period for direct print longer than the holding period with a print instruction from the printer driver of the terminal apparatuses 32 and 33. For example, with the example in FIG. 12, it is conceivable, for example, to make the holding period for data being held for direct print (“Direct Document 123”) five days, and to make the holding period for data being held by a print instruction of the printer driver of the terminal apparatuses 32 and 33 (“User DEF Document 456” and “User GHI Tabulation 123”) three days. However, from the viewpoint of security, it is also conceivable to make the holding period for direct print short. Accordingly, it is preferable that the holding period can be set as desired by an administrator or the like who manages the equipment.

The above <Description of Processing When Direct Print Data Is Received> and <Description of Print Hold Processing> are mainly descriptions of the processing when data is received for direct print from outside, but below, print hold processing performed by the printer driver of a terminal apparatus, which also includes the case of opening password-protected data that has been sent by confidential mail in an application and then printing out the data, is described.

<Description of Print Hold Processing with Printer Driver of Terminal Apparatus>

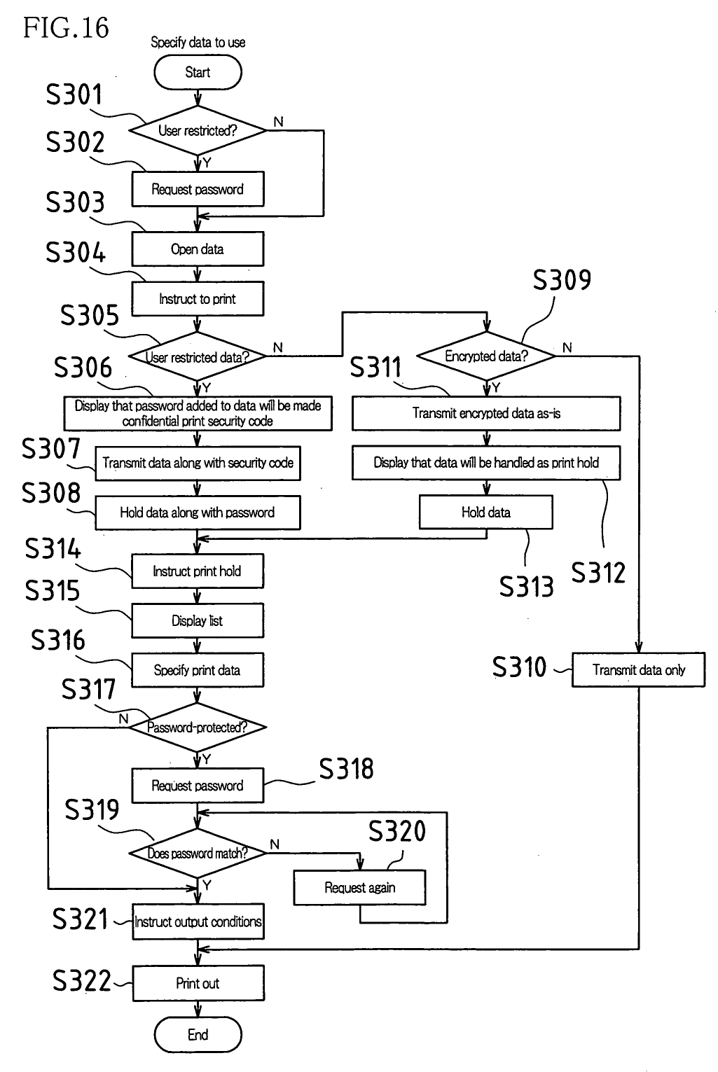

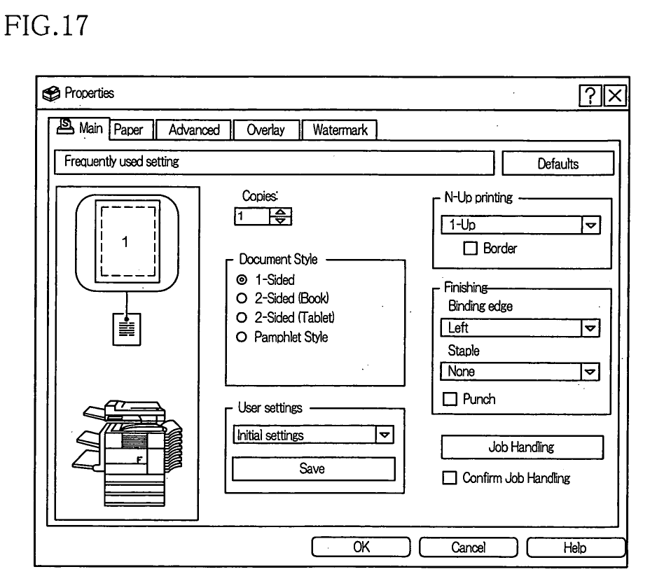

Print hold processing with the printer driver of a terminal apparatus is described with reference to the flowchart shown in FIG. 16 and the example display screen of the display portion 4b shown in FIG. 17.

For example, when password-protected data that has been sent to the terminal apparatus 32 by confidential mail is opened with the terminal apparatus 32, when, for example, the file for the data is opened in an application, first, confirmation is made of whether or not there is a user restriction in the file, i.e., whether or not a password is necessary (Step S301), and when a password is necessary (when judged YES in Step 301), a request is made to input a password (Step S302). Because it is basically expected that the user who uses the terminal apparatus 32 will know this password (for example, “abcd”), the user inputs the password “abcd” according to this request. When confirming that the password matches, the data in the file is opened (Step S303).

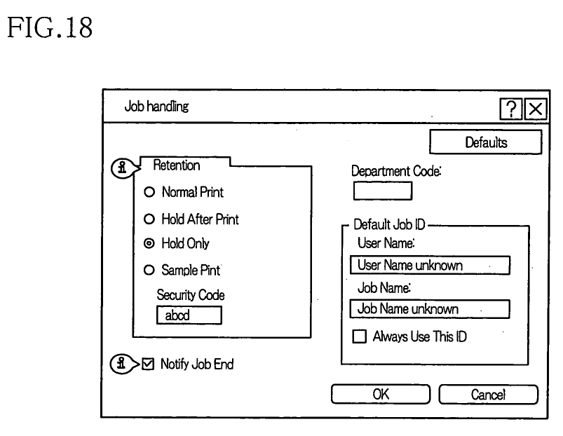

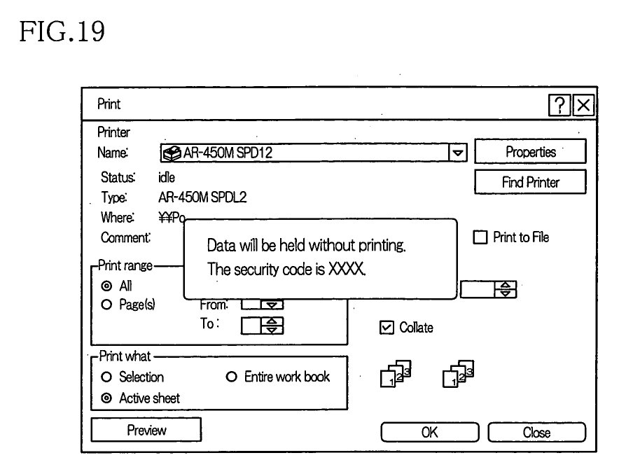

Next, when the user makes a print instruction in order to print the opened data (for example, successively selecting “File”, “Print” from the screen of the open file data) (Step S304), the print driver that received this print instruction confirms whether or not a password has been added to the print data (Step S305). When the result is that a password had been added (when judged YES in Step S305), the added password “abcd” is used as-is as a confidential print password (security code). Also, the printer driver that received the above print instruction displays the print settings screen shown in FIG. 17 on the screen of the terminal apparatus 32. When, for example, the user selects simplex printing (1-Sided) from this screen, and clicks on the “Job Handling” button in the lower right of the screen, the job handling screen shown in FIG. 18 is displayed. In this screen, it is indicated that this print data is held in the digital multifunction equipment 1 without being printed, and setting of the above password “abcd” as a security code is shown. When the user clicks on the “OK” button in the lower right of this job handling screen, the print screen shown in FIG. 19 is displayed. As shown in FIG. 19, in the print screen at this time, a message screen is displayed superimposed notifying that the password “abcd” that was added in confidential mail will be used as-is as a confidential print security code (Step S306). When the user clicks on the “OK” button in the lower right of the screen after confirming the contents of this message, the print data is transmitted along with the security code “abcd” to the digital multifunction equipment 1 (Step S307).

On the other hand, with the digital multifunction equipment 1, same as the processing described in the above section <Description of Processing When Direct Print Data Is Received>, password-protected data is saved to the hard disk 13 as print hold without being printed (Step S308).

Also, in Step S305, when it is judged that a password has not been added (judged NO), next, it is confirmed whether or not the data is encrypted (S309). When the result is that it is not encrypted data (when judged NO in step S309), print data is transmitted as-is to the digital multifunction equipment 1 (Step S310). Thus, with the digital multifunction equipment 1, same as the processing described in the above section <Description of Print Hold Processing>, received print data is immediately printed out (Step S322).

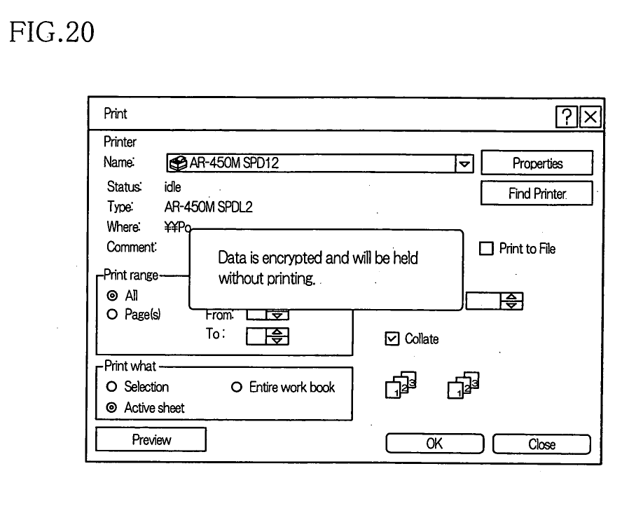

On the other hand, in Step S309, when it is judged that the print data is data that has been encrypted (judged YES), the encrypted data is transmitted as-is to the digital multifunction equipment 1 (Step S311). At this time, as shown in FIG. 20, a message is displayed on the screen of the terminal apparatus 32 notifying that because the mail is encrypted it will be handled as print hold (Step S312).

On the other hand, with the digital multifunction equipment 1, same as the processing described in the above section <Description of Print Hold Processing>, received encrypted data is saved to the hard disk 13 as print hold data (Step S313).

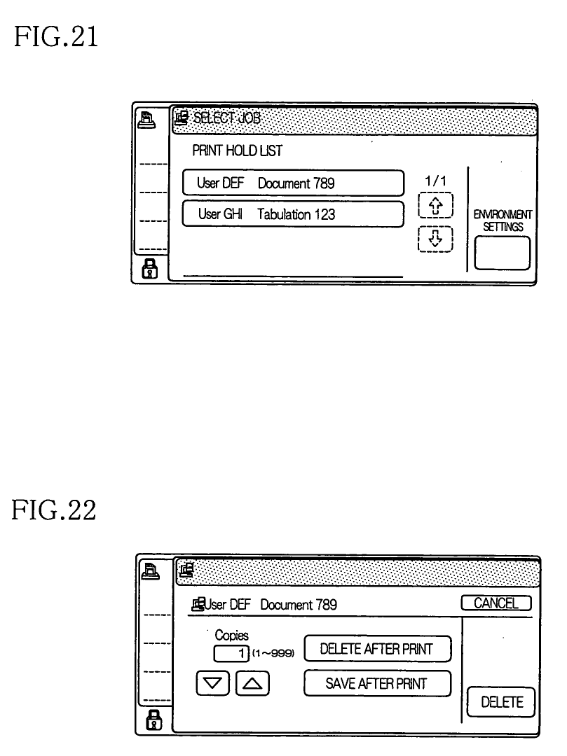

Afterward, the user goes to the location of the digital multifunction equipment 1, and presses the function button 42b labeled “PRINT” in the input portion 4a shown in FIG. 2 (Step S314). Thus, for example, a print hold list screen shown in FIG. 21 is displayed on the display portion 4b (Step S315). Here, supposing that “User DEF Document 789” is data that has been saved along with the above security code “abcd”, the user selects “User DEF Document 789” from this list screen as data to be printed (Step S316). The equipment control portion 8 confirms whether or not a password (security code) has been added to this data that has been selected (Step S317). In this case, because a password (security code “abcd”) has been added to the selected data (judged YES in Step S317), the password input screen (see FIG. 13) is displayed superimposed on the print hold list screen in display portion 4b (Step S318). Accordingly, the user inputs the above “abcd” in the input window of this password input screen.

The equipment control portion 8 confirms whether or not the password that has been input matches the password saved along with the data in the hard disk 13 (Step S319). When the result is that the passwords do not match (when judged NO in Step S319), password input is requested again (Step S320), and the operation returns to the processing in Step S319. In this case, because the passwords match (judged YES in Step S319), an output condition settings screen is displayed in the display portion 4b, as shown in FIG. 22.

The user sets output conditions in this output condition settings screen (Step S321). Specifically, the number of output copies is set in this output condition settings screen. Also, setting is performed for how to handle the data after printing.

Here, when “DELETE AFTER PRINT” is selected, after the data for “User DEF Document 789” is printed out, the data for “User DEF Document 789” is deleted from the hard disk 13.

On the other hand, when “SAVE AFTER PRINT” is selected, after the data for “User DEF Document 789” is printed out (Step S322), the data for “User DEF Document 789” is saved in the hard disk 13.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An image output apparatus that outputs an image based on data received from outside, comprising:
a protection status confirmation portion that confirms a protection status of the received data, and
a control portion that controls an output process of the image according to the protection status of the data that has been confirmed by the protection status confirmation portion.

2. The image output apparatus according to claim 1, wherein the control portion comprises a setting portion that sets the process of output as an image according to the protection status of the received data.

3. The image output apparatus according to claim 2, wherein the control portion comprises an encryption confirmation portion that confirms a presence or absence of encryption for the received data, and the setting portion sets the process of output as an image according to the presence or absence of encryption that has been confirmed by the encryption confirmation portion.

4. The image output apparatus according to claim 2, wherein the control portion comprises a password confirmation portion that confirms the presence or absence of a password for the received data, and the setting portion sets the process of output as an image according to the presence or absence of a password that has been confirmed by the password confirmation portion.

5. The image output apparatus according to claim 3 or 4, wherein when the control portion has confirmed that the received data is encrypted or that a password has been added, when performing output as an image, output is performed by an instruction from a user.

6. An image output apparatus that prints out an image based on data received from outside, comprising:
a processing method setting portion that sets, in advance, a method of print processing when direct print data is received.

7. The image output apparatus according to claim 6, wherein the processing method setting portion:
sets a processing method that unconditionally prints out when the received direct print data is only simple data in a predetermined file format,
sets a processing method that temporarily holds the data, and prints out the data in response to the user's output instruction when the received data is encrypted, and
sets a processing method that temporarily holds the data, and prints out the data in response to password input from the user when a password has been added to the received data.

8. The image output apparatus according to claim 6, further comprising an output setting portion that sets whether or not to print the received direct print data.

9. The image output apparatus according to claim 6, wherein data processed for direct print and data processed by a print instruction from an ordinary driver is classified and displayed as a job list.

10. The image output apparatus according to claim 6, further comprising a deleting portion that deletes from within the apparatus whose output is delayed when a holding period set in advance passes,
wherein different holding periods may be set for data being held for direct print and data being held by a print instruction from an ordinary driver.

11. An image output apparatus that outputs an image based on data received from outside, comprising:
a judgment portion that judges whether or not usage restriction information is attached to the received data,
an output restriction portion that restricts output of the received data with the data in a saved state when it has been judged by the judgment portion that usage restriction information has been attached,
a holding portion that holds the usage restriction information attached to the data as output condition information that makes it possible to output data whose output has been restricted by the output restriction portion, and
an input portion that inputs the output condition information when a request is made to output the data whose output has been restricted.

12. The image output apparatus according to claim 11, further comprising a notification portion that notifies that data received from outside is saved in the print hold state, restricting output of that data.

13. A printer driver that generates print data toward an image recording apparatus that has a confidential print function, comprising:
a judgment portion that judges whether or not usage restriction information is attached to the data when generating held data as print data, and
a job generating portion that generates print data in which the usage restriction information is made a confidential printing security code when it has been judged by the judgment portion that usage restriction information has been attached.

14. The printer driver according to claim 13, further comprising a notification portion that notifies a user that the print data will be processed as print hold, and that the security code, which is the hold code when that processing is performed, is the usage restriction information that was attached to the data.
